(19) United States
(12) Patent Application Publication
(10) Pub. No.: US 2026/0264446 A1
(43) Pub. Date: Sep. 10, 2026

(54) PAINT PALETTE SYSTEM

(71) Applicant: Saanvi Seela, Orlando, FL (US)

(72) Inventor: Saanvi Seela, Orlando, FL (US)

(21) Appl. No.: 19/070,201

(22) Filed: Mar. 4, 2025

(51) Int. Cl. B44D 3/02

(52) U.S. Cl. CPC B44D 3/02

(57) ABSTRACT

A paint palette system includes a palette base having a main body with a central indentation, a thumb hole, and a plurality of paint wells. The main body includes a pair of paint brush clips along the top surface, and a handle that extends from the bottom surface. The system includes a plurality of palette sheets, each having a central indentation, a thumb hole and a plurality of paint wells. The plurality of palette sheets are stacked in a vertical configuration on the top of the palette base with the central indentations, thumb holes and paint wells aligned. The palette sheets also include a central opening into which the paint brush clips are located, and each of the palette sheets are individually removable from the palette base by a pull tab.

### TECHNICAL FIELD

The present invention relates generally to the field of artistic painting, and more particularly to a palette system having a handheld palette base with a plurality of removable and disposable paint trays.

### BACKGROUND

The statements in this section merely provide background information related to the present disclosure and may not constitute prior art.

Palettes are commonly used by artistic painters in order for the painter to have easy access to any number of different types or colors of paints, along with a dedicated space to mix the same when creating custom blends or colors. Most palettes are constructed from a rigid non-permeable material such as glass or composites, for example, and include a gripping surface for allowing the painter to easily grasp the palette with a single hand during use.

Because palettes are designed to be reusable, they are typically constructed from materials that are able to withstand repeated and direct contact with many different types of paint without staining. Additionally, the palettes must be able to withstand repeated exposure to chemicals such as paint thinners and/or paint additives which may be used by painters to either clean the palette or to alter the appearance of the paints they are working with.

The ability for a palette to be completely cleaned between uses is critical, as any remaining residues may greatly affect or alter new paints being applied onto the canvass when the palette is subsequently used. For this reason, most palettes are expensive to purchase and have a recommended limited lifespan of between 50 and 100 uses before they should be discarded.

The present invention, directed to a paint palette with disposable trays differs from the conventional art in a number of aspects. The manner by which will become more apparent in the description which follows, particularly when read in conjunction with the accompanying drawings.

### SUMMARY OF THE INVENTION

The present invention is directed to a paint palette system. One embodiment of the present invention can include a palette base having a generally circular shaped main body with a central indentation, a thumb hole, and a plurality of paint wells. The main body can also include a paint brush clip along the top surface, and a handle that extends from the bottom surface.

In one embodiment, the system can include a plurality of removable palette sheets. Each of the palette sheets can also include a central indentation, a thumb hole, and a plurality of paint wells. The plurality of palette sheets can be aligned and stacked in a vertical configuration onto the top of the palette base such that the central indentations, thumb holes and paint wells are aligned. The palette sheets can also include a central opening into which the paintbrush clips are located. Each of the palette sheets can include a pull tab and can be individually removed from the palette base and discarded after use.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of one embodiment of a paint palette system that is useful for understanding the inventive concepts disclosed herein.

FIG. 2 is a perspective view of the palette base of the palette system in accordance with one embodiment of the invention.

FIG. 3 is a perspective view of the plurality of palette sheets of the palette system in accordance with one embodiment of the invention.

FIG. 4 is a perspective view of the palette system in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, a “unit” means a series of identified physical components which are linked together and/or function together to perform a specified function.

As described throughout this document, the term “about” “approximately” “substantially” and “generally” shall be used interchangeably to describe a feature, shape, or measurement of a component within a tolerance such as, for example, manufacturing tolerances, measurement tolerances or the like.

As described herein, the term “removably secured,” and derivatives thereof shall be used to describe a situation wherein two or more objects are joined together in a non-permanent manner so as to allow the same objects to be repeatedly joined and separated.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

As described herein, the term “connector” includes any number of different elements that work alone or together to repeatedly join two items together in a nonpermanent manner. Several nonlimiting examples of connectors include, but are not limited to thread-to-connect, twist-to-connect, and push-to-connect type devices, opposing strips of hook and loop material (e.g., Velcro®), attractively oriented magnetic elements or magnetic and metallic elements, buckles clamps and compression fittings, for example. Each illustrated connector and complementary connector can be permanently secured to the illustrated portion of the device via a permanent sealer such as glue, adhesive tape, or stitching, for example.

As described herein, the term “resilient memory” is defined as the ability of a component to maintain a particular shape and to attempt to return to the particular shape after being bent, folded, twisted, or otherwise manipulated.

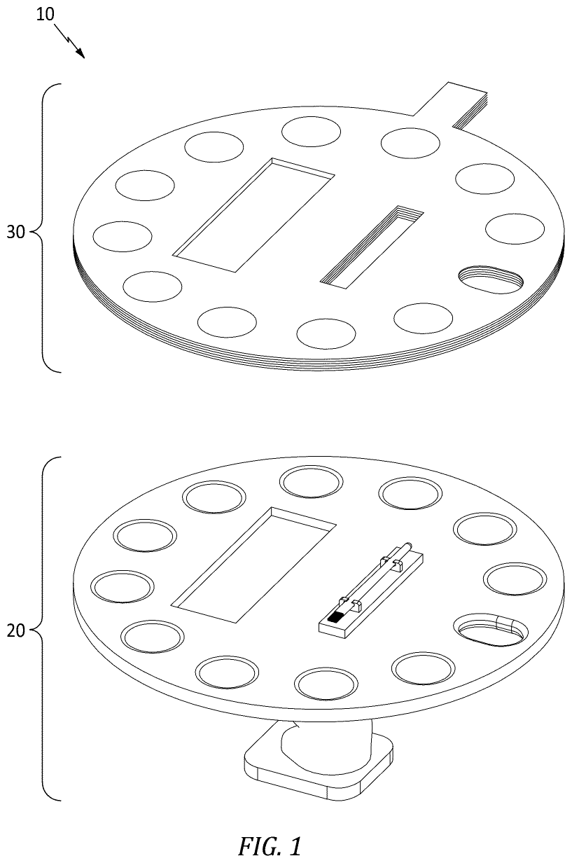

FIGS. 1-4 illustrate one embodiment of a paint palette system 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As shown in the drawings, one embodiment of the paint palette system 10 includes, essentially, a palette base 20 having a plurality of tear off palette sheets 30 which can be removably secured thereto.

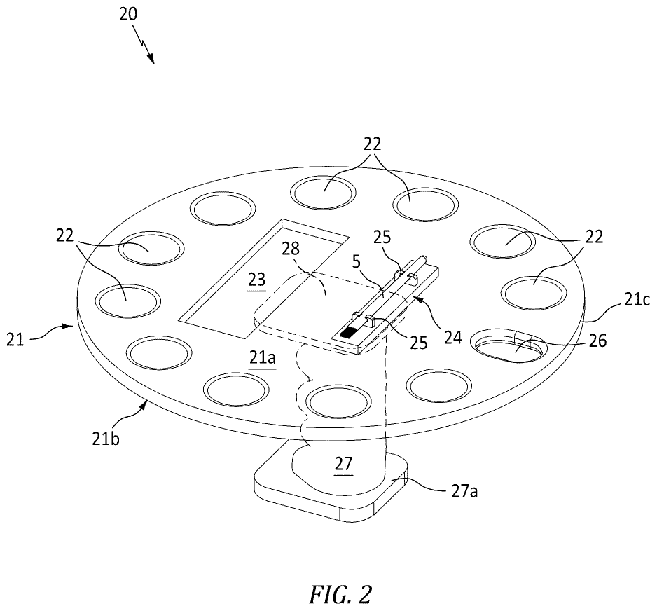

As shown best at FIG. 2, the palette base 20 can include a generally circular or kidney-shaped main body member 21 having a top surface 21a, a bottom surface 21b, and a continuous outer edge 21c. In the preferred embodiment, a plurality of concave wells 22 can be provided along the top surface 21a of the main body at a location adjacent to the outer edge 21c. Each of the wells can include any number of different shapes and sizes and can function with the above-described sheets to receive and store any number of different paints when utilizing the system.

In one embodiment, the main body can include a large central indentation 23. The central indentation can preferably be positioned along the center area of the top surface 21a of the palette base 21, and can be substantially (e.g., 3-5 times) larger than each of the wells 22. Such a feature being suitable for use with the below described sheets to provide the user with a large area to mix and blend paints during use of the system.

In one embodiment, the main body can include a platform 24 that extends upward from the top surface 21a at a location adjacent to the central indentation 23. The platform 24 can include a pair of clips 25 each having resilient arms that extend upward to receive and store a paint brush 5 or other tool.

In one embodiment, a thumb hole 26 can be provided along the main body. The hole can include any number of different shapes and sizes and can function to accommodate the thumb of a user in grasping the palette base when using the device.

In one embodiment of the main body can further include a handle 27 that extends downward from the bottom surface 21b. In one embodiment, the handle can be permanently connected to the main body, and can be used in conjunction with, or instead of the hole 26 to allow the user to grasp and carry the device. Alternatively, the handle 27 can be removably connected to the bottom surface of the main body via a connector 28 such as magnets or strips of hook and loop material, for example.

In either instance, it is preferred that the bottom end of the handle include a flat surface 27a so as to allow the palette base to stand upright on any surface when not being carried by the user.

As described herein, the palette base, the clips and the handle may be formed from any number of porous or non-porous materials that are, for example, relatively strong and stiff for their weight. Several nonlimiting examples include but are not limited to various metals or metal alloys (e.g., aluminum or alloys thereof), plastic/polymers (e.g., high-density polyethylene (HDPE), rigid polyvinyl chloride (PVC), polycarbonate), various natural materials (e.g., wood) and/or various composite materials (e.g., carbon fibers in a polymer matrix, fiberglass, etc.).

Although described above with regard to a particular shape, size, or location of component, this is for illustrative purposes only. To this end, the palette base can include any number of different shapes and sizes. Additionally, each of the wells, the platform and the central indentation may also include any number of other shapes, sizes, and locations along the palette base.

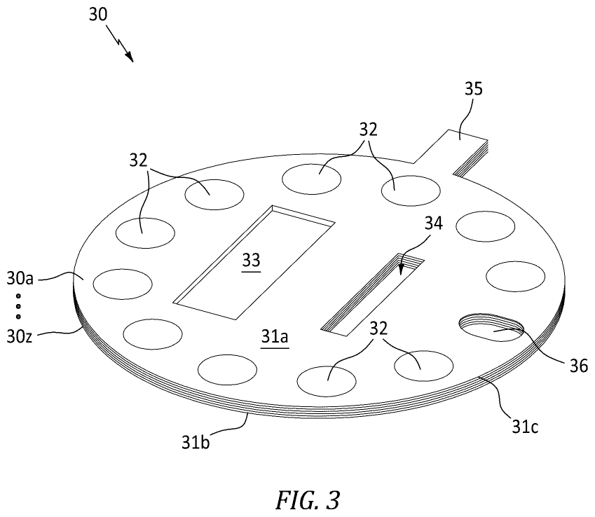

As shown best at FIG. 3, the plurality of palette sheets 30 can be arranged in a vertically stacked configuration such that the top sheet 30a is positioned above the bottom sheet 30z. As described herein, each of the individual palette sheets can be identical in nature and can include a shape and size that is complementary to the shape and size of the palette base described above.

More specifically, each of the palette sheets can include a main body having a top surface 31a, a bottom surface 31b, and a continuous outer edge 31c. Each sheet can include a plurality of concave wells 32 and a central indentation 33 that are complementary in shape, size, and location to the wells 22 and indentation 23 on the palette base described above.

In one embodiment, a first opening 34 and a second opening 36 can be provided through each of the sheets. The first and second openings can each include a shape, size and location that are complementary to the shape, size, and location of the platform 24 and hole 26 on the palette base.

Opening 34 is provided to permit a user to engage the platform 24 to insert and remove a paintbrush 5 or other tool at all times, and regardless of how many sheets on the stack are remaining. Moreover, each time a sheet is removed, the platform and brush are not disturbed. Opening 36 is provided to permit the user to pass their thumb through the hole 26 and rest atop the uppermost sheet.

As described herein, each of the plurality of sheets 30a-30z of the stack 30 can be constructed from a thin (e.g., 1 mm-5 mm) piece of malleable plastic. In one embodiment, each of the sheets can be removably secured together utilizing a no-residue adhesive that is positioned along a portion of the back surface 31b of each sheet, so as to adhere each sheet to the subsequent sheet in the stack. Of course, other embodiments are contemplated wherein the sheets are removably stacked together using a different type of connector, such as magnets, strips of hook and loop material and/or utilizing static cling so as to not require the use of adhesives at all.

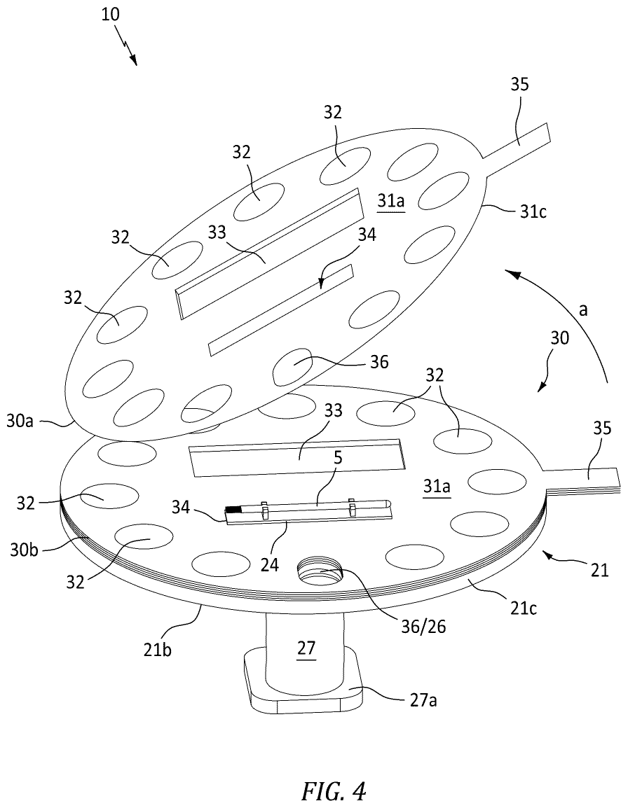

FIG. 4 illustrates one embodiment of the system 10 in operation. As shown, the plurality of tear off palette sheets 30 can be positioned onto the top surface of the palette base 21 such that each of the wells, indentations and openings are aligned as described above. When

The palette system can be used in the expected manner whereby a user can deposit paints into each of the wells and utilize the central indentation area to mix colors. As shown by arrow A, when the user is finished with their project, they can remove the uppermost sheet 30a of the stack via a pulling force on the tab 35 to reveal the next sheet 30b in the stack.

Such a feature allows users to quickly and easily remove soiled sheets after each use to reveal a clean sheet for their next use without having to physically clean the device. Moreover, when each sheet of the stack has been used, the user can purchase another stack of sheets for use with the same palette base, thus eliminating waste and eliminating the need to replace the palette after a set number of uses.

As to a further description of the manner and use of the present invention, the same should be apparent from the above description. Accordingly, no further discussion relating to the manner of usage and operation will be provided.

As described herein, one or more elements of the device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A palette system, comprising:
a palette base having a top surface, a bottom surface and a side surface;
a plurality of palette wells that are positioned along the top surface of the palette base; and
at least one palette sheet having a plurality of sheet wells,
wherein the at least one palette sheet is configured to be positioned onto the top surface of the palette base with each of the plurality of sheet wells being positioned within the plurality of palette wells.

2. The system of claim 1, further comprising:
a thumb hole that is positioned along the palette base.

3. The system of claim 2, further comprising:
an opening that is positioned through each of the at least one palette sheet.

4. The system of claim 3, wherein the opening includes a shape and a size that is complementary to a shape and a size of the thumb hole, and
wherein the thumb hole and opening are vertically aligned when the at least one palette sheet is positioned onto the palette base.

5. The system of claim 1, further comprising:
a palette indentation that is positioned along a center portion of the palette base.

6. The system of claim 5, further comprising:
a sheet indentation that is positioned along a center portion of each of the at least one palette sheet.

7. The system of claim 6, wherein the sheet indentation includes a shape and a size that is complementary to a shape and a size of the palette indentation, and
wherein the sheet indentation and the palette indentation are vertically aligned when the at least one palette sheet is positioned onto the palette base.

8. The system of claim 1, wherein the at least one palette sheet comprises a plurality of palette sheets that are stacked together vertically.

9. The system of claim 8, wherein each of the plurality of palette sheets includes a shape and a size that is complementary to a shape and a size of the palette base.

10. The system of claim 9, wherein each of the plurality of palette sheets includes a pull tab.
